(19) United States
(12) Patent Application Publication
(10) Pub. No.: US 2020/0216264 A1
(43) Pub. Date: Jul. 9, 2020

(54) SYSTEM AND METHOD FOR USE IN FACILITATING EXECUTION OF A WORK ORDER

(71) Applicant: The Boeing Company, Chicago, IL (US)

(72) Inventors: Fernando L. Martinez, Hanahan, SC (US); Erica Nicole Hunt, Moncks Corner, SC (US)

(21) Appl. No.: 16/243,607

(22) Filed: Jan. 9, 2019

(51) Int. Cl. B65G 1/137

(52) U.S. Cl. CPC B65G 1/1373

(57) ABSTRACT

An automated production system for facilitating execution of a work order within a facility. The system includes a fetch robot at an inventory storage station (ISS), an automated guided vehicle (AGV) moving autonomously between the ISS and work stations, and a controller in communication with the fetch robot and AGV. The controller receives the work order, directs the AGV to move to the ISS, receive a first signal that the AGV has arrived at the ISS, and directs, based on receiving the first signal, the fetch robot to retrieve a part associated with the work order from within the ISS, wherein the fetch robot loads the part onto the AGV. The controller also receives a second signal that retrieval and loading of the part has been completed, and directs, based on receiving the second signal, the AGV to deliver the part from the ISS to the work station.

### FIELD

The field relates generally to automated material handling solutions and, more specifically, to systems and methods of automating and/or facilitating execution of a work order.

### BACKGROUND

Some known manufacturing processes are performed in very large, open facilities wherein part storage, pre-production, and final assembly are performed at different locations within the facility. Accordingly, fulfillment of a work order typically includes determining what parts are needed to complete the work order, manually retrieving the parts from part storage, using a runner to transport the parts from part storage to a work station, and then performing pre-production at the work station by a technician. Thus, the work order fulfillment process is a time-consuming and laborious task that may be susceptible to human error. Some known facilities implement robotic devices to perform one or more of the tasks articulated above. However, control of the robotic devices that perform the different tasks is typically delegated to distinct, task-specific systems, thereby limiting interaction and coordination between the robotic devices.

This section is intended to introduce the reader to various aspects of art that may be related to various aspects of the disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF DESCRIPTION

In one aspect, an automated production system for use in facilitating execution of a work order within a facility is provided. The system includes a fetch robot positioned at an inventory storage station, an automated guided vehicle configured to move autonomously within the facility between the inventory storage station and a number of work stations, and a controller in communication with the fetch robot and the automated guide vehicle. The controller is configured to receive the work order from a production database, which identifies a work station and a part storage location for each of a number of parts associated with the work order. The controller is configured to direct the automated guided vehicle to move to the inventory storage station, receive a first signal that the automated guided vehicle has arrived at the inventory storage station, and direct, based on receiving the first signal, the fetch robot to retrieve the number of parts associated with the work order from the identified part storage locations within the inventory storage station, wherein the fetch robot is configured to load the parts onto the automated guided vehicle. The controller is also configured to receive a second signal that retrieval and loading of the parts has been completed by the fetch robot, and direct, based on receiving the second signal, the automated guided vehicle to deliver the loaded parts from the inventory storage station to the location of the identified work station.

In another aspect, a method for use in facilitating execution of a work order within a facility is provided. The method includes receiving, by a controller, the work order from a production database, which identifies a work station and a part storage location for each of a number of parts associated with the work order. The method further includes directing, by the controller, an automated guided vehicle to move to an inventory storage station within the facility, receiving, by the controller, a first signal that the automated guided vehicle has arrived at the inventory storage station, directing, based on receiving the first signal, a fetch robot to retrieve the number of parts associated with the work order from the identified part storage locations for each part within the inventory storage station, wherein the fetch robot is configured to load the number of parts onto the automated guided vehicle, receiving a second signal that retrieval and loading of the parts has been completed by the fetch robot, and directing, based on receiving the second signal, the automated guided vehicle to deliver the loaded parts from the inventory storage station to a location of the identified work station.

In yet another aspect, a non-transitory computer-readable medium having computer-executable instructions embodied thereon for use in facilitating execution of a work order within a facility is provided. When executed by at least one processor, the computer-executable instructions cause the processor to receive the work order from a production database, where the work order identifies a work station and a part storage location for each of a number of parts associated with the work order, direct an automated guided vehicle to move to an inventory storage station within the facility, receive a first signal that the automated guided vehicle has arrived at the inventory storage station, direct, based on receiving the first signal, a fetch robot to retrieve the number of parts associated with the work order from the identified part storage locations for each part within the inventory storage station, wherein the fetch robot is configured to load the parts onto the automated guided vehicle, receive a second signal that retrieval and loading of the parts has been completed by the fetch robot, and direct, based on receiving the second signal, the automated guided vehicle to deliver the loaded parts from the inventory storage station to a location of the identified work station.

Various refinements exist of the features noted in relation to the above-mentioned aspects of the present disclosure. Further features may also be incorporated in the above-mentioned aspects of the present disclosure as well. These refinements and additional features may exist individually or in any combination. For instance, various features discussed below in relation to any of the illustrated embodiments of the present disclosure may be incorporated into any of the above-described aspects of the present disclosure, alone or in any combination.

### BRIEF DESCRIPTION OF THE DRAWINGS

FIG. 1 is a block diagram of an example automated production system.

FIG. 2 illustrates an example facility that may use the automated production system shown in FIG. 1 to complete a work order.

FIG. 3 is a flow diagram illustrating an example sequence of process steps for use in facilitating execution of a work order.

FIG. 4 is a flow diagram illustrating example controller logic that may be used to augment the series of process steps shown in FIG. 3.

Corresponding reference characters indicate corresponding parts throughout the drawings.

### DETAILED DESCRIPTION

The implementations described herein relate to systems and methods of automating and/or facilitating execution of a work order. Execution of the work order is facilitated by a controller that acts as a centralized hub for use in the reception and dissemination of real-time information and instructions between different machines used to complete the work order. For example, the system described herein includes machines such as a fetch robot that retrieves parts needed for completion of the work order from part storage, an automated guided vehicle (AGV) that delivers the parts from part storage to a work station, the work station itself, and a wearable device for use by a technician.

In operation, the controller receives a work order and determines, for example, the parts needed for completion of the work order, the availability of a work station and a technician capable of completing the work order, and an inventory of available fetch robots and AGVs. The controller facilitates execution of the work order by receiving feedback from the machines and directing the machines to perform tasks at iterative junctures in the production process based on the feedback received from the different machines. Thus, the controller expects to receive feedback from the machines at certain junctures in the process, and facilitates continuation of the production process when the feedback is received. As such, the systems and methods described herein provide an order of communications and commands that facilitates the completion of a work order in an efficient, controlled, and error-reducing manner.

As used herein, an element or step recited in the singular and preceded with the word “a” or “an” should be understood as not excluding plural elements or steps, unless such exclusion is explicitly recited. Furthermore, references to “exemplary implementation” or “one implementation” of the present disclosure are not intended to be interpreted as excluding the existence of additional implementations that also incorporate the recited features.

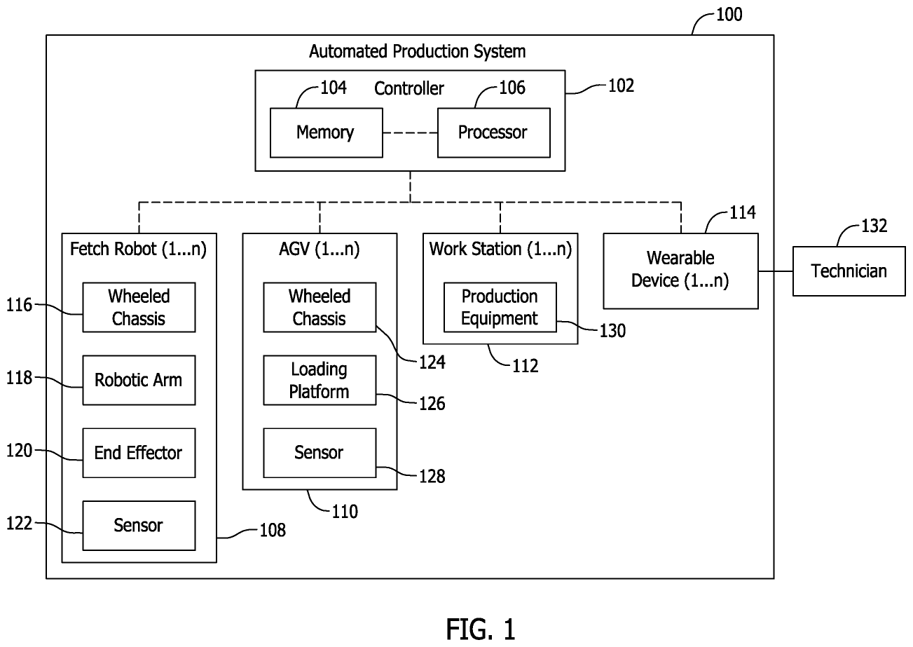

FIG. 1 is a block diagram of an example automated production system 100. In the example implementation, automated production system 100 includes a controller 102 having a memory 104 and a processor 106, including hardware and software, coupled to memory 104 for executing programmed instructions. Processor 106 may include one or more processing units (e.g., in a multi-core configuration) and/or include a cryptographic accelerator (not shown). Controller 102 is programmable to perform one or more operations described herein by programming memory 104 and/or processor 106. For example, processor 106 may be programmed by encoding an operation as executable instructions and providing the executable instructions in memory 104.

Processor 106 may include, but is not limited to, a general purpose central processing unit (CPU), a microcontroller, a microprocessor, a reduced instruction set computer (RISC) processor, an open media application platform (OMAP), an application specific integrated circuit (ASIC), a programmable logic circuit (PLC), and/or any other circuit or processor capable of executing the functions described herein. The methods described herein may be encoded as executable instructions embodied in a computer-readable medium including, without limitation, a storage device and/or a memory device. Such instructions, when executed by processor 106, cause processor 106 to perform at least a portion of the functions described herein. The above examples are exemplary only, and thus are not intended to limit in any way the definition and/or meaning of the term processor.

Memory 104 is one or more devices that enable information such as executable instructions and/or other data to be stored and retrieved. Memory 104 may include one or more computer-readable media, such as, without limitation, dynamic random access memory (DRAM), synchronous dynamic random access memory (SDRAM), static random access memory (SRAM), a solid state disk, and/or a hard disk. Memory 104 may be configured to store, without limitation, executable instructions, operating systems, applications, resources, installation scripts and/or any other type of data suitable for use with the methods and systems described herein.

Instructions for operating systems and applications are located in a functional form on non-transitory memory 104 for execution by processor 106 to perform one or more of the processes described herein. These instructions in the different implementations may be embodied on different physical or tangible computer-readable media, such as memory 104 or another memory, such as a computer-readable media (not shown), which may include, without limitation, a flash drive and/or thumb drive. Further, instructions may be located in a functional form on non-transitory computer-readable media, which may include, without limitation, smart-media (SM) memory, compact flash (CF) memory, secure digital (SD) memory, memory stick (MS) memory, multimedia card (MMC) memory, embedded-multimedia card (e-MMC), and micro-drive memory. The computer-readable media may be selectively insertable and/or removable from controller 102 to permit access and/or execution by processor 106. In an alternative implementation, the computer-readable media is not removable.

Automated production system 100 further includes multiple machines that perform tasks that aid in completion of a work order. In the example implementation, automated production system 100 includes one or more fetch robots 108, one or more AGVs 110, one or more work stations 112, and one or more wearable devices 114. Fetch robots 108, AGVs 110, work stations 112, and wearable devices 114 are all, either by wired or wireless connectivity, in communication with controller 102 such that information is transmittable therebetween, as will be described in more detail below. In addition, automated production system 100 includes multiple fetch robots 108, AGVs 110, work stations 112, and wearable devices 114 such that multiple work orders may be executed simultaneously and/or such that redundancy is provided in the event of a task is unable to be completed, such as because of a malfunctioning machine.

Fetch robots 108 may be any robotic device that enables automated production system 100 to function as described herein. As used herein, a “fetch robot” is a mobile robot that is capable of retrieving objects from storage locations, and delivering the objects to an awaiting vehicle without requiring human assistance. In the example implementation, fetch robot 108 includes a wheeled chassis 116, a robotic arm 118 coupled to wheeled chassis 116, an end effector 120 coupled to robotic arm 118, and a sensor 122. End effector 120 may be any device capable of facilitating movement of an object from one location to another, such as a gripping device, a magnetic device, and the like. Sensor 122 is any device that enables automated production system 100 to function as described herein. For example, sensor 122 is operable for visually identifying a part, and determining that the part is positioned within a predetermined part storage location. Thus, sensor 122 provides verification that the part is the correct part for the work order, and that the part to be retrieved from the predetermined part storage location is available for retrieval. One model of a fetch robot with a robotic arm that is configured to identify and retrieve parts from specified part storage locations may be, for example, a Fanuc Robot R-2000ic that is manufactured by Fanuc corporation.

AGVs 110 may be any vehicle that enables automated production system 100 to function as described herein. As used herein, an “automated guided vehicle” is a mobile robot that is capable of following a path without requiring human assistance. AGV 110 may be used for towing objects, carrying loads, transporting materials, and/or performing other suitable types of operations. In the example implementation, AGV 110 includes a wheeled chassis 124, a loading platform 126 coupled to wheeled chassis 124, and a sensor 128. Sensor 128 is any device that enables automated production system 100 to function as described herein. For example, sensor 128 is operable for determining whether one or more parts have been loaded onto or unloaded from loading platform 126. An example sensor 128 includes, but is not limited to, a visual feedback device, or a load sensor coupled to loading platform 126.

Work stations 112 may be any designated location within a facility or device that enables automated production system 100 to function as described herein. In addition, work stations 112 include production equipment 130 that may be used to perform a production operation on the parts delivered to work station 112 by AGV 110. Example production equipment includes, but is not limited to, a numerically controlled machining apparatus that receives and executes a program with instructions for directing the numerically controlled machining apparatus to perform machining of one or more of the number of parts. The production equipment also includes a robotic apparatus that receives and executes a program with instructions for directing the robotic apparatus to perform manufacturing operation of ply cutting or drilling holes. Production equipment may also include a work table, a computer terminal, and task-specific tools, assemblies, and machines. In one implementation, production equipment 130 operates autonomously or semi-autonomously. The controller 102 is capable of controlling a transceiver to transmit one or more signals to production equipment at a work station, which may include a program for the production equipment, and directs the production equipment 130 to perform a production operation on at least one part. Thus, controller 102 is capable of monitoring a status of, and/or receiving information from, production equipment 130 to facilitate continuation of a production process.

Wearable devices 114 may be any device that enables automated production system 100 to function as described herein. For example, wearable devices 114 may be a smart watch, a smart phone, or any other device capable of being carried or worn by a technician 132. Wearable devices 114 are operable for receiving information from controller 102, and for transmitting information to controller 102 when prompted by technician 132. In the example implementation, technician 132 is trained to operate a particular work station 112 and its associated production equipment 130, if applicable.

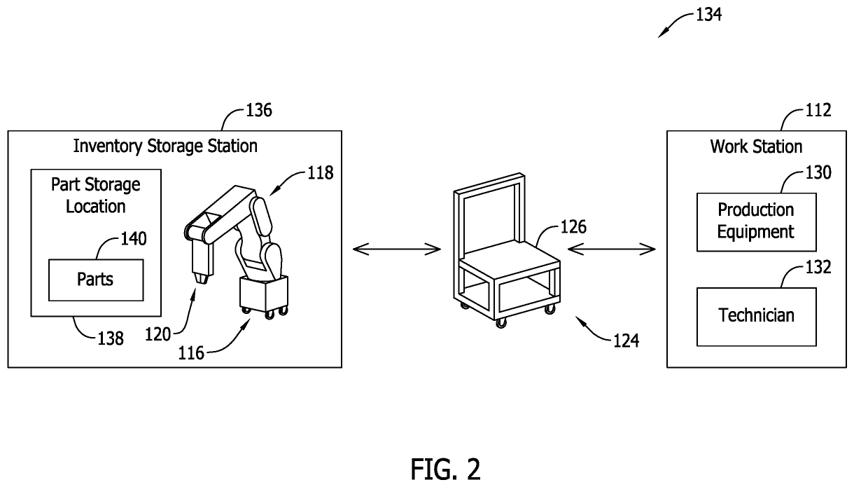

FIG. 2 illustrates an example facility 134 that may use automated production system (shown in FIG. 1) to complete a work order. In the example implementation, facility 134 includes work station 112 and an inventory storage station 136 located remotely from each other. At least one fetch robot 108 is positioned at inventory storage station 136. In addition, inventory storage station 136 includes part storage locations 138 and parts 140 stored in part storage locations 138. Fetch robot 108 is operable for retrieving parts from part storage locations 138, such as by using end effector 120 to retrieve parts 140 from part storage locations 138. AGV 110 is configured to move autonomously within facility 134 between inventory storage station 136 and work station 112. Thus, as will be explained in more detail below, AGV 110 moves to inventory storage station 136, fetch robot 108 loads parts 140 onto AGV 110, and then AGV 110 delivers parts 140 to work station 112 to be worked on by production equipment 130 or technician 132 (shown in FIG. 1).

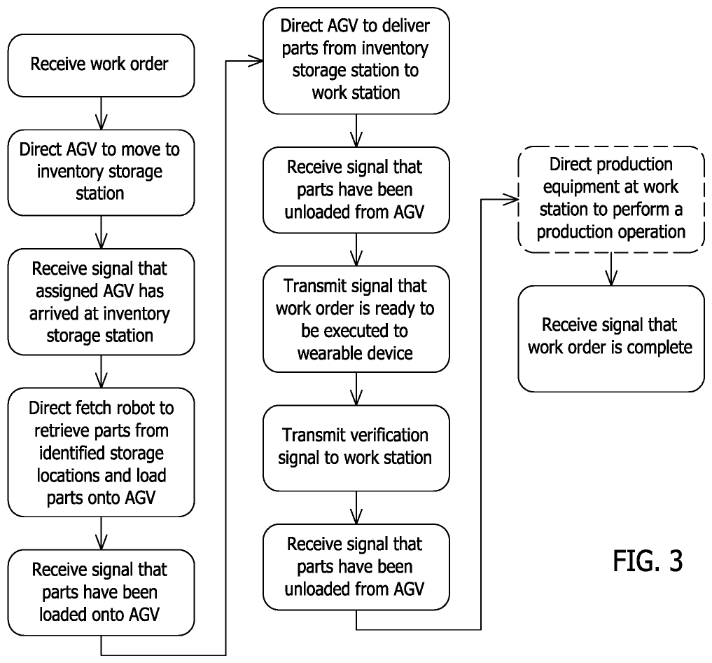

FIG. 3 is a flow diagram illustrating an example sequence of process steps for use in facilitating execution of a work order. For example, the sequence of process steps may be executed by controller 102 (shown in FIG. 1) to facilitate execution of a work order. In operation, controller 102 receives a work order from a production database (not shown). The production database stores a queue of incomplete work orders, and the production database may be augmented with additional work orders over time. In one implementation, the work order includes information identifying a location of an assigned work station 112 that includes production equipment 130 capable of completing the work order, an identification of the number of parts needed to complete the work order, part storage locations 138 for each identified part 140 within inventory storage station 136 (all shown in FIG. 2), and a production operation for production equipment at the identified work station to perform on at least one of the number of parts.

Controller 102 then directs an available AGV 110 (shown in FIG. 2) to move to inventory storage station 136. For example, in one implementation, controller 102 maintains an inventory of available AGVs 110, and controls a transceiver to wirelessly transmit a signal to one of the available AGV's, which assigns and directs one of the available AGVs 110 to move to a pickup location at inventory storage station 136. Controller 102 then receives a signal that includes information indicating that the assigned AGV 110 has arrived at the pickup location at an inventory storage location where a fetch robot 108 is located. In the example implementation, the signal is transmitted to controller 102 from AGV 110 itself when AGV 110 determines it has arrived at the pickup location. Alternatively, the inventory storage station 136 or fetch robot 108 may include a proximity sensor for detecting that the particular assigned AGV is proximate to the inventory storage location 136 and fetch robot 108, and the signal may be transmitted to controller 102 from the inventory storage station 136 or fetch robot 108.

Once the signal that AGV 110 has arrived is received, controller 102 then directs an available fetch robot 108 to retrieve a number of parts 140 (shown in FIG. 2) associated with the work order from within inventory storage station 136. For example, controller 102 maintains an inventory of available fetch robots 108, and controls a transceiver to wirelessly transmit a signal to one of the available fetch robots 108, which assigns and directs one of the available fetch robots 108 to retrieve the number of parts 140. As described above, fetch robot 108 includes sensor 122 for visually identifying parts 140 in each part storage location 138 (shown in FIG. 2), and for verifying that each part 140 located in part storage locations 138 associated with the work order is the correct part needed for completion of the work order. If a part 140 is missing from a particular part storage location 138, or if an incorrect part is stored in a particular part storage location 138, fetch robot 108 transmits a signal to controller 102 to prompt further investigation.

Once all parts 140 needed for completion of the work order are retrieved, fetch robot 108 moves to the pickup location and loads parts 140 onto the waiting AGV 110. Controller 102 then receives a signal that retrieval and loading of parts 140 onto AGV 110 has been completed. The signal may be received from fetch robot 108 indicating that the loading process has been completed, or from AGV 110 as a result of feedback received from sensor 128 (shown in FIG. 1). For example, sensor 128 may be operable to determine the presence of a load on loading platform 126. Once controller 102 receives the signal that retrieval and loading of parts 140 onto AGV 110 has been completed, controller 102 updates the inventory of available fetch robots 108 and directs AGV 110 to deliver parts 140 from inventory storage station 136 to work station 112.

Controller 102 then receives a signal that AGV 110 has arrived at a drop off location at work station 112. In the example implementation, the signal is transmitted to controller 102 from AGV 110 itself when AGV 110 determines it has arrived at the drop off location. Alternatively, work station 112 may include a proximity sensor, and the signal may be transmitted to controller 102 from work station 112.

Controller 102 then transmits a signal, to a wearable device 114 associated with a technician 132 (shown in FIG. 1) assigned to the work order and having the appropriate expertise, that the work order is ready to be executed at work station 112. Controller 102 also transmits a verification signal to work station 112. The verification signal contains data used to verify that the number of parts 140 delivered to work station 112 is associated with the work order to be executed at work station 112. For example, the data may include the inventory of parts 140 needed to complete the work order, and technician 132 may manually cross-reference the inventory with parts 140 delivered to work station 112 to verify all parts 140 needed to complete the work order have been delivered.

In the example implementation, technician 132 unloads parts 140 from AGV 110, and controller 102 then receives a signal that parts 140 have been unloaded from AGV 110. For example, the signal may be received from technician 132 via wearable device 114 or production equipment 130, or from AGV 110 as a result of feedback received from sensor 128. Once controller 102 receives the signal that parts 140 have been unloaded from AGV 110, controller 102 updates the inventory of available AGVs 110 to include the now-empty and available AGV 110. AGV 110 is now available to perform a delivery operation associated with a different work order, or to return to a home location, for example.

In one implementation, controller 102 is in communication with production equipment 130 at work station 112 that is operable either autonomously or semi-autonomously. Thus, if applicable, controller 102 transmits a signal to production equipment at the identified work station, which may include a numerical control program with instructions for directing the production equipment to perform a manufacturing operation, and directs the production equipment 130 to perform a production operation on the at least one part 140 after the signal that parts 140 have been unloaded from AGV 110 has been received. Controller 102 then receives a signal that the work order is complete. The signal may be received from production equipment 130 or from technician 132 via wearable device 114 or production equipment 130, for example. Controller 102 may then update the inventory of available work stations 112 to include the now-idle work station 112.

It should be understood that the discussion of the sequence of process steps is for example purposes, and that one or more of the process steps may be performed simultaneously to expedite completion of the work order.

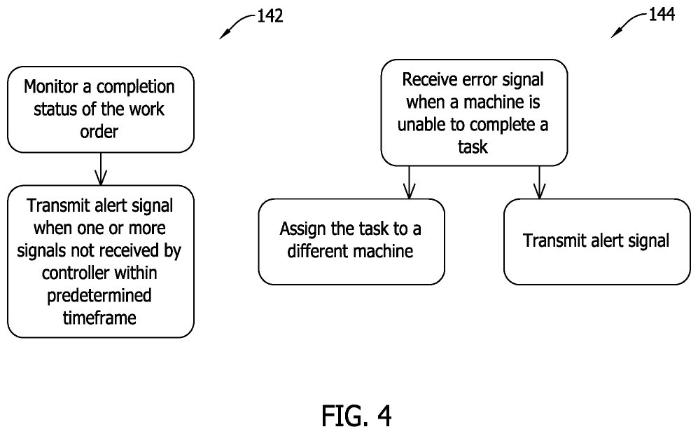

FIG. 4 is a flow diagram illustrating example controller logic that may be used to augment the series of process steps shown in FIG. 3. In the example implementation, a first controller logic 142 includes monitoring a completion status of the work order, and transmitting an alert signal when one or more signals have not been received by controller 102 (shown in FIG. 1) within a predetermined timeframe. Controller 102 determines an estimate of an amount of time needed to perform each task by the machines in the sequence of process steps noted above, and uses the estimate to determine a timeframe in which a signal should be received from the machines to indicate that the task is complete. If the signal is received within the timeframe, no action is taken and controller 102 facilitates the execution of the work order as planned. If the signal is not received within the timeframe, the alert signal is transmitted to a higher authority, such as a human operator, to prompt further investigation of the delay.

For example, in one implementation, controller 102 estimates an amount of time needed for AGV 110 to travel to and from work station 112 and inventory storage station 136 (all shown in FIG. 2), and transmits an alert signal if a signal that AGV 110 has arrived at either work station 112 or inventory storage station 136 has not been received within the estimated timeframe. In some implementations, controller 102 also transmits an alert signal based on an amount of time needed for fetch robot 108 to retrieve parts 140 from part storage locations 138 (all shown in FIG. 2), based on an amount of time needed for technician 132 (shown in FIG. 1) to arrive at work station 112, or based on an amount of time needed for production equipment 130 (shown in FIG. 2) to complete a production operation, for example.

In addition, a second controller logic 144 includes receiving an error signal when a machine (e.g., fetch robot 108, AGV 110, or production equipment 130) is unable to complete a task, and either assigning the task to a different machine or transmitting an alert signal based on the type of alert signal received from the machine. For example, in some implementations, the error signal includes a signal received from fetch robot 108, AGV 110, or production equipment 130 that a malfunction has occurred such that the particular machine is no longer able to complete its assigned task. In this instance, controller 102 references its inventory of available fetch robots 108, AGVs 110, or work stations 112, and assigns the task to a different machine. Alternatively, in one implementation, the error signal includes a signal received from fetch robot 108 that one or more parts 140 are unable to be retrieved from part storage locations 138. In this instance, controller 102 transmits an alert signal to prompt further investigation.

This written description uses examples to disclose various implementations, including the best mode, and also to enable any person skilled in the art to practice the various implementations, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An automated production system for use in facilitating execution of a work order within a facility, the system comprising:
a fetch robot positioned at an inventory storage station;
an automated guided vehicle configured to move autonomously within the facility between the inventory storage station and a number of work stations; and
a controller in communication with the fetch robot and the automated guide vehicle, the controller configured to:
receive the work order from a production database, which identifies a work station and a part storage location for each of a number of parts associated with the work order;
direct the automated guided vehicle to move to the inventory storage station;
receive a first signal that the automated guided vehicle has arrived at the inventory storage station;
direct, based on receiving the first signal, the fetch robot to retrieve the number of parts associated with the work order from the identified part storage locations within the inventory storage station, wherein the fetch robot is configured to load the number of parts onto the automated guided vehicle;
receive a second signal that retrieval and loading of the parts has been completed by the fetch robot; and
direct, based on receiving the second signal, the automated guided vehicle to deliver the loaded parts from the inventory storage station to the location of the identified work station.

2. The system in accordance with claim 1 further comprising a wearable device configured to be worn by a technician, wherein the controller is further configured to:
receive, from the automated guided vehicle, a third signal that the automated guided vehicle has arrived at the work station with the parts; and
transmit, based on receiving the third signal, a fourth signal that the work order is ready to be executed to the wearable device.

3. The system in accordance with claim 1, wherein the controller is further configured to:
receive a fifth signal that the parts have been unloaded from the automated guided vehicle; and
update an inventory of available automated guided vehicles based on the fifth signal.

4. The system in accordance with claim 1, wherein the controller is further configured to:
receive a sixth signal that the work order is complete; and
update an inventory of available work stations based on the sixth signal.

5. The system in accordance with claim 1, wherein the controller is configured to receive the work order that includes a location of the work station associated with the work order, an identification of the number of parts needed to complete the work order, and a part storage location for each identified part within the inventory storage station, and a production operation for production equipment at the identified work station to perform on at least one of the number of parts.

6. The system in accordance with claim 1, wherein the fetch robot comprises a robotic arm and an end effector configured to retrieve the parts from within the inventory storage station, the fetch robot further comprising a sensor configured to determine if the parts are positioned within a predetermined part storage location within the inventory storage station.

7. The system in accordance with claim 1, wherein the controller is further configured to transmit a verification signal to the work station, wherein the verification signal contains data used to verify that the parts delivered to the work station is associated with the work order to be executed at the work station.

8. The system in accordance with claim 1, wherein the controller is further configured to:
monitor a completion status of the work order based on the reception of one or more signals within a predetermined timeframe; and
transmit an alert signal when the one or more signals are not received within the predetermined timeframe.

9. The system in accordance with claim 1, wherein the controller is further configured to receive an error signal from at least one of the fetch robot, the automated guided vehicle, or the work station when a task is unable to be completed.

10. The system in accordance with claim 9, wherein the controller is further configured to assign the task to a different fetch robot, automated guided vehicle, or work station based on the error signal.

11. The system in accordance with claim 5, wherein the controller transmits a signal to production equipment at the identified work station, configured to cause the production equipment to perform the production operation on at least one of the number of parts.

12. A method for use in facilitating execution of a work order within a facility, the method comprising:
receiving, by a controller, the work order from a production database, which identifies a work station and a part storage location for each of a number of parts associated with the work order;
directing, by the controller, an automated guided vehicle to move to an inventory storage station within the facility;
receiving, by the controller, a first signal that the automated guided vehicle has arrived at the inventory storage station;
directing, based on receiving the first signal, a fetch robot to retrieve the number of parts associated with the work order from the identified part storage locations for each part within the inventory storage station, wherein the fetch robot is configured to load the number of parts onto the automated guided vehicle;
receiving, by the controller, a second signal that retrieval and loading of the parts has been completed by the fetch robot; and
directing, based on receiving the second signal, the automated guided vehicle to deliver the loaded parts from the inventory storage station to a location of the identified work station.

13. The method in accordance with claim 12 further comprising:
receiving, from the automated guided vehicle, a third signal that the automated guided vehicle has arrived at the work station with the parts; and
transmitting, based on receiving the third signal, a fourth signal that the work order is ready to be executed to a wearable device configured to be worn by a technician.

14. The method in accordance with claim 12 further comprising:
receiving a fifth signal that the parts have been unloaded from the automated guided vehicle; and
updating an inventory of available automated guided vehicles based on the fifth signal.

15. The method in accordance with claim 12 further comprising:
receiving a sixth signal that the work order is complete; and
updating an inventory of available work stations based on the sixth signal.

16. The method in accordance with claim 12 further comprising transmitting a verification signal to the work station, wherein the verification signal contains data used to verify that the parts delivered to the work station is associated with the work order to be executed at the work station.

17. The method in accordance with claim 12 further comprising:
monitoring a completion status of the work order based on the reception of one or more signals within a predetermined timeframe; and
transmitting an alert signal when the one or more signals are not received within the predetermined timeframe.

18. The method in accordance with claim 12 further comprising receiving an error signal from at least one of the fetch robot, the automated guided vehicle, or the work station when a task is unable to be completed.

19. The method in accordance with claim 12, further comprising transmitting a signal to production equipment at the identified work station to cause the production equipment to perform a production operation on at least one of the number of parts delivered to the work station.

20. A non-transitory computer-readable medium having computer-executable instructions embodied thereon for use in facilitating execution of a work order within a facility, wherein, when executed by at least one processor, the computer-executable instructions cause the processor to:
receive the work order from a production database, wherein the work order identifies a work station and a part storage location for each of a number of parts associated with the work order;
direct an automated guided vehicle to move to an inventory storage station within the facility;
receive a first signal that the automated guided vehicle has arrived at the inventory storage station;
direct, based on receiving the first signal, a fetch robot to retrieve the number of parts associated with the work order from the identified part storage locations for each part within the inventory storage station, wherein the fetch robot is configured to load the parts onto the automated guided vehicle;
receive a second signal that retrieval and loading of the parts has been completed by the fetch robot; and
direct, based on receiving the second signal, the automated guided vehicle to deliver the loaded parts from the inventory storage station to a location of the identified work station.
